(19) United States
(12) Patent Application Publication
(10) Pub. No.: US 2025/0383185 A1
(43) Pub. Date: Dec. 18, 2025

(54) LASER DETERRENT APPARATUS, METHOD, AND SYSTEM

(71) Applicant: Steven Wayne Goldstein, Delray Beach, FL (US)

(72) Inventor: Steven Wayne Goldstein, Delray Beach, FL (US)

(21) Appl. No.: 19/235,925

(22) Filed: Jun. 12, 2025

Related U.S. Application Data
(60) Provisional application No. 63/659,308, filed on Jun. 12, 2024.

(51) Int. Cl. F41H 13/00; H01S 3/067; H01S 3/1123; H01S 3/16

(52) U.S. Cl. CPC F41H 13/005; H01S 3/06716; H01S 3/1123; H01S 3/1616; H01S 3/1643; H01S 2302/00

(57) ABSTRACT

A deterrent apparatus, method and system including a laser configured to operate between 1000 nm and 2100 nm, a controller, and a detector. The controller is configured to instruct the laser to apply Q-switch pulses of laser to act as a deterrent to a subject. The laser may be a Thulium Fiber Laser, configured to operate between 1800 nm and 2100 nm. The laser may be a YAG Laser, configured to operate between 1000 nm and 2000 nm.

### REFERENCE TO THE RELATED PATENT APPLICATION

The present application claims benefit of U.S. Provisional Application No. 63/659,308, filed on Jun. 12, 2024, the entire disclosure of which is incorporated herein by reference.

### TECHNICAL FIELD

This disclosure generally relates to interdiction in the field of physical security. In particular, a deterrent effect apparatus, method, and system designed to induce temporary peripheral nervous system pain.

### BACKGROUND

Dermis is a major component of the human or animal body and comprises abundant sensory receptors. Axons carry signals from the receptors to the synapses, where they transfer information to the dendrites of other neurons. Receptors, such as specialized periphery sensory neurons known as nociceptors (e.g., pain receptors) can be targeted and activated to send signals that travel to the cortex faster than other receptors such as mechanosensitive or mechanothermal when external stimulus is applied. Nociceptors are specialized peripheral sensory neurons found in the dermis and other tissues, and function to detect potentially noxious and damaging stimuli and transmit these signals to the spinal cord and brain alerting a person to pending discomfort, pain.

Various types of stimuli are capable of permanently harming tissue, including mechanical (such as pressure, piercing, laceration), thermal (such as extreme temperatures, hot and cold), and chemical (such as burns, rash, deformation). Different nociceptor populations respond to specific types of stimuli, which in turn lead to a diversity of pain qualities. These qualities are well documented via the McGill Pain Questionnaire (SF-MPQ). The publication uses the following words to characterize the sensory qualities of pain: throbbing, shooting, stabbing, sharp, cramping, gnawing, hot-burning, aching, heavy, tender, and splitting.

Photonic deterrents can be used as stimuli in subjects, including humans and animals, to leverage the nociceptive responses to protect a secured area. For example, certain photonic apparatus, such as lasers, can be configured to specifically induce a pain response by photodisruption, for example, before photoablation, and consequently potential thermal damage, is incurred. For example, activating fast acting afferent action potentials can elicit an unwelcomed and painful response in a subject (e.g., human or animal) before any permanent tissue damage can occur in contrast to the slower responding Aδ and C fibers which are triggered by thermal and or mechanical stimuli.

The amount of energy and repetition frequency of the deterrent on targeted locations on the subject may be referred to as the “time on target.” With photonic deterrent such as lasers, the greater the time on the same location on the subject, the more likely the location on the subject receiving the deterrent will increase in tissue temperature which, due to photoablation, may lead to permanent tissue damage. Conversely, a photodisruptive effect causes small shockwaves on the subject's tissue which activates the nociceptors prior to causing any photoablation.

A 2 μm Thulium Fiber Laser (“TFL”), which may be nano-pulsed, may be capable of inducing a photodisruptive effect by triggering the nociceptors. For example, if the TFL is configured to ultra-fast pulses (e.g., 10 ps to 100 ns) with the adequate amount of energy density, it will induce photodisruption rather than photoablation, which can occur with prolonged exposure such as longer pulses (e.g., 1 ms-100 s).

Moreover, the wavelengths emitted by TFLs may be particularly useful for temporary deterrents directed at human skin as the water absorption coefficient, which determines the absorption by water of radiation emitted by a laser, is near peak levels. For a TFL at around a 1940 nm wavelength, the water absorption coefficient is μa=129.2 cm−1 which is near the absolute peak water absorption coefficient of around 140 cm−1. This is a higher absorption rate than other lasers wavelengths such as Holmium: YAG laser around 2120 nm wavelength. This higher water absorption coefficient means that the photodisruption action causes a “shock wave” which will have significant deterrent effect. Specifically, water is present in the outer layers of dermis and therefore not very deep. Accordingly, when the TFL pulse stimulates the dermis, the dermal water quickly absorbs the energy and consequently activates the nociceptors without needing to penetrate deep into the tissue which requires more time and causes photoablation and tissue damage.

The laser deterrent could incorporate quality switching or “Q-switch” lasers to achieve nano-pulsing, e.g., which can control photonic output to concentrate energy into intense bursts and/or series of ultra-fast pulses which can trigger/excite the pain transmitting Aβ fibers to achieve photodisruptive response before initiating the tissue damage response. This ensures that the applied laser deterrent, such as the switched TFL, can be applied safely without causing permanent damage and staying within Maximum Permissible Exposure (“MPE”) limits.

Using specific targeting techniques and laser configurations, the application of these laser deterrents can be used to influence behavior such as: deny, slow down, stop, change direction, drop weapon, reverse direction, move crowd and/or otherwise manage and deter the physical actions of one or more subjects which have entered or intend to enter protected zones.

As the subject may be moving, the available time on target on a specific location of the subject may be limited. This can be affected by a variety of factors, but could be limited to 1-2 ms to stimulate specific location(s) on a moving subject.

These techniques, including the various laser configurations, can be managed in real time using artificial intelligence (“AI”) including, for example, machine learning models which can control the various laser characteristics, sensing, and detection, and deterrent determinations. Given the short amount of time required to apply a, or a plurality of, deterrent(s), the various situational processing, as well as to determine the characteristics for the deterrent and then instruct the deterrent component to apply the characteristics, an AI system may be necessary.

Additionally, given the necessity and complexity of the sensors, the system can collect, and process obtained data even when not interdicting and/or otherwise applying a deterrent. This data can be used for a variety of purposes, including to identify situational or conditional abnormalities in the environment including actions by individuals, animals, or natural activity and train the system.

### SUMMARY

The present disclosure is directed to using specific targeting techniques and photonic energy configurations as a deterrent effect to protect a secured area(s) such as by deterring or delaying unauthorized subjects (e.g., individuals or animals) from gaining access to the secured area(s). Using these interdiction techniques and configurations, the system can induce temporary pain reactions to subjects in and around the secured or protected areas in a manner that does not cause permanent thermal tissue damage while operating within predetermined MPE limits such as defined under ANSI z136.1, ANSI z136.6 and European IEC-60825-1 standards.

This can be accomplished using a laser in a non-contact (contactless) process to induce pain and thereby quickly stimulate the subject's nervous system of a pending “countermeasure” without causing permanent tissue injury.

The disclosure of U.S. Pat. No. 11,747,480, filed on Aug. 18, 2021, is hereby incorporated by reference in its entirety.

### BRIEF DESCRIPTION OF DRAWINGS

The present invention is illustrated by way of example and not limited in the figures of the accompanying drawing in which like references indicate similar elements.

FIG. 1 illustrates an exemplary system according to an embodiment of the present disclosure.

### DETAILED DESCRIPTION

All identically numbered reference characters correspond to each other so that a duplicative description of each reference character in the drawings may be omitted. As discussed below, the various steps, processes, configurations, techniques, and system components discussed herein may be combined, separated, and/or the order may be changed depending on the system requirements and desired outcomes.

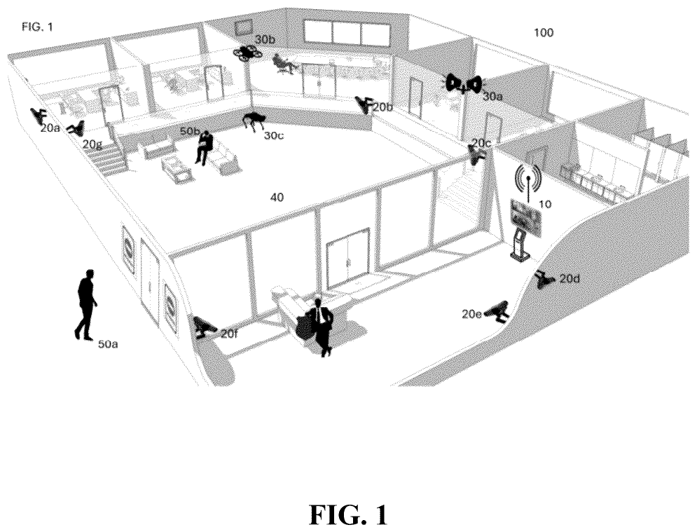

FIG. 1 illustrates an exemplary system according to an embodiment of the present disclosure.

As depicted the system 100 includes computer 10 which communicates with sensor components 20a-n and deterrents 30a-n in and around a secured area 40. Additionally, present in and around the secured area 40 could be subjects 50a-n.

Computer 10 may comprise a central processing unit (CPU), memory, and/or peripherals such as a monitor depending on the configuration of the system. The computer 10 may be located at the site where the sensors 20 and deterrents 30 are located or may be located elsewhere such as configured as a server in the cloud or elsewhere.

The system 100 may be configured without a single computer 10, but wherein other components of the system either include computing functionality individual or as part of a network wherein certain processing in performed either by one component or split/synchronized between multiple components. For example, as discussed below, certain components of the system 100 may be positioned in fixed locations and/or movable/dynamic such as on an uncrewed aerial vehicle or robotic assets and any, all, or none of these may include the processing functionality as part of the various embodiments discussed herein.

The computer 10 may also comprise an AI engine which may comprise machine learning model[s]. The AI engine may be used for various purposes discussed below including, but not limited to, threat identification and detection; deterrent selection; determining, monitoring, and modeling subject behavior; and configuring and instructing deterrents including various laser and beam characteristics.

The AI engine can rely on various sensor data discussed below for inputs.

The AI engine inputs include, and the AI engine may be trained with, various situational data including environmental characteristics including time of day, lighting, temperature, humidity, location of sun, structures, material, or any other factors, distance, speed, movement, date analysis, biometrics and biometrics ID, and object recognition, eyeball recognition, head detection, hand detection, skin detection, pose detection, distance from protection area, and number of subjects. The training could also include human behavior training data based on human response to various deterrents, environments, and circumstances and data obtained by the sensors. The input and training data may also include data related to the various deterrents and their systemic requirements and configurations as discussed below such as to control the applied laser beam deterrent.

Any or all of the above inputs and training may also be supplemented and/or reinforced based on data obtained by the sensors 20 within the system 100 over time and/or at certain time intervals. Using this sensor data as training data, the system 100 can recognize normal activities versus abnormal activities.

The sensors 20 may comprise any type of sensor technology including but not limited to a black and white camera, color camera hyperspectral camera, LiDAR, radar, infrared, temperature, humidity, lux level, SWIR, millimeter wave (MMW) and electromagnetic sensors, audio sensor (e.g., microphone), pressure sensor, or any sensor as needed depending on the requirements and configuration of the system 100.

The sensors 20 can be used for several purposes including, but not limited to, observation, activation, detection, tracking, and identification of subjects 50 that are entering or near the secured area 40 and other monitoring near to and within the secured area 40. This includes, identification of subjects 50 not only as potential threats, who should not be entering the location and/or performing activities which are not permitted at the location, who may enter the secured site 40 and identification of individuals, e.g., to determine whether they exist on whitelists or blacklists and/or otherwise have authority to enter secure area 40.

This can also include identifying and monitoring specific activities in and around the secured area 40, e.g., the secured area 40 may be comprised of indoor, outdoor, or mixed environments having indoor and outdoor features and/or accessibility. For example, the sensors 20 can monitor and track specific activities by the subject 50 including whether the subject 50 is engaged in behaviors that convey bad intent or aggression or detection by CV of objections that could be considered threatening (e.g., carrying or pointing a weapon).

Alternatively, or in combination, the sensors 20 and the AI engine may be used to track the activities to determine if the actions performed by the subject 50 are consistent with the authority allocated to that subject. For example, if the subject 50 is permitted to enter certain locations within the secured area, but not others, or to access certain equipment, the sensors 20 can be used to monitor those activities and identify any abnormalities based on predetermined rules or based on activities identified as abnormal by the AI engine.

Additionally, the sensors 20 can also be used with regard to the tracking and targeting necessary for the application of deterrent effects. For example, as discussed below, the system may require distance information between deterrent components and the subject 50 that can be determined by or with the assistance of sensors 20. Similarly, as discussed below, the sensors 20 can be used to identify locations of exposed skin on the subject and/or target specific location on the subject such as predetermined regions on the face where there could be specific nociceptor regions to target. Moreover, the switching application of the laser controlled by the computer 10 and using sensory dataflow from the sensors 20 can be used to further assure the MPE of the deterrents 30 are not exceeded as to induce enduring harm or long-term side-effects on the targeted subject 50.

The sensors 20 can be used to monitor the impact of any deterrent applied to the subject 50. For example, the system 100 can be configured to apply persistent deterrent effects wherein certain deterrents may be selected and applied based on the response of the subject 50 to a first applied deterrent. For example, the AI engine can, based on the monitoring, determine whether additional deterrents need to be applied including, for example, whether greater or lesser deterrents should be applied.

The processing of this sensor data can be performed either by the sensors 20 themselves or the computer 10 as discussed above.

The system 100 can utilize AI such as machine learning models to accomplish the above functionality. For example, the system can use machine learning models to process camera data of the subject to identify the subject's 50 face and/or for identifying objects the subject 50 may be holding such as a weapon.

The system 100 can identify and/or be used to monitor a secured area 40. This can include using thermal detection, day/night detection, as well as various environmental detection for monitoring.

The system 100 can identify and/or be used to monitor a subject[s] of interest 50. “Subject” or “subject of interest” may be used to describe the individual or animal that the system is monitoring, targeting, and/or applying a deterrent, but other terms may also be used herein such as “target”, “intruder”, “interloper” or other similar designations.

The deterrents 30 could comprise any type of deterrent component and/or could comprise a plurality and/or combination of different deterrents. For example, the system can determine a deterrent, apply the deterrent, analyze the subject's reaction, and then determine what and what subsequent deterrents should be applied.

In embodiments discussed herein, the deterrents 30 comprise lasers. As discussed below, certain laser types and configurations may be preferred depending on the requirements and desired system functionality.

In certain embodiments it is preferable to use a laser emitting photonic energy around 2,000 nanometers wavelength, though the exact wavelength may vary depending on the system design, available hardware, desired deterrent, and/or other environmental-based concerns/conditions (such as humidity, fog, or the presence of other chemical airborne agents) that may be more or less tolerable to laser intensities being driven by the deterrents 30.

The type of laser could comprise a TFL which generally operates between 1800 nm and 2100 nm depending on the design. Alternatively, Yttrium Aluminum Garnet (“YAG”) lasers may be used. For example, Neodymium-Doped YAG Lasers (“Nd:YAG”) which can operate at or around 1064 nm can be used depending on the system requirements.

Certain wavelengths can be beneficial for various applications. Wavelengths in the non-visible ranges, such as those discussed above, provide numerous benefits. For example, by using non-visible lasers (infrared and ultraviolet), these deterrents can be used in locations with restrictions on visible light such as airports. Accordingly, deterrent systems employing these laser deterrents emitting non-visible light could be used in protected areas such as airports where visible light may not be allowed in view of the dangers caused by light directed into plane cockpits.

Similarly, non-visible laser deterrents may be preferable in areas where visible light would not be preferred such as movie theaters, or other experiences where visible might may affect the user experience. This also allows the originating laser source to remain completely covert. Thus, the subject will have no comprehension of where the source is emitting from unless they are using a viewing system capable of viewing the light at the specific wavelengths such as, for example, by SWIR detection. Additionally, security personnel could also be provisioned with a SWIR camera headset to track the deterrents.

Additionally, these non-visible ranges are less likely, if at all, to result in direct serious damage to the retina of the of individuals. This is beneficial as it not only provides impactful but not lasting damage, but also will be less likely to result in hysteria if used in crowds. Specifically, the system can methodically target certain individuals to control the crowd (e.g., such as individuals on the outside of the crowd) and target locations on the subjects to control the subjects' movement (e.g., applying a deterrent to a certain side of the subject's face to cause the subject to turn) and thereby control the movement of the crowd by controlling the edges and movement of the crowd. This can be accomplished without affecting the entire crowd, such as may occur if the crowd members perceived lasers flying around or applying loud noises or other deterrents which might shock a plurality of crowd members. This, in turn, will further reduce the risk of serious injury such as to physically fragile individuals by direct-energy visible deterrents or by crowd-panic that could result in crowd collapse, crushes, or stampedes. To accomplish this, the AI engine may be trained to identify crowds, and crowd formation, as well as crowd response.

Moreover, the wavelengths emitted by TFLs may be useful as deterrents when directed at human skin. The water absorption coefficient, which determines the absorption by water of infrared radiation emitted by a laser, for a TFL at around a 1940 nm wavelength is μa=129.2 cm−1. This is near the absolute peak water absorption coefficient of around 140 cm−1. This is a higher absorption rate than average Holmium:YAG laser around 2120 nm wavelength at α=31.8 cm−1. See below.

This means that the water in the skin tissue will react with greater absorption the emitted light from a TFL than a YAG laser. More specifically, the higher water absorption coefficient means that the water optical penetration depth is shallower such that the laser deterrent does not need to penetrate the tissue as deep and therefore has a lower risk of permanent damage. Moreover, the deeper the energy needs to travel, the more heat is produced and therefore the higher likelihood of permeant tissue damage.

For example, this is illustrated in the following table:

Accordingly, the TFL can activate the nociceptors and thereby trigger a response from the individual without photoablation and/or tissue damage. The photoablation technique damages and vaporizes tissue by and superheating of tissue fluids.

This is also true for other types of tissue as well:

Moreover, the frequency, pulse energy, and pulse length/duration ranges are greater for TFL lasers. For example, current TFLs can operate at up to 2,200 Hz whereas HO:YAG lasers may only be operable up to 80 Hz.

Additionally, the characteristics of the pulses TFL are distinct from those of a continuous wave Thulium:YAG laser which also operates around 2,0000 nm wavelength.

These lasers, including those around 1-2 micron wavelength, are also “melanin content agnostic,” meaning that they apply equally across different levels of skin pigmentation (i.e. skin colors). This results in numerous benefits, including but not limited to that there is no risk to the efficacy of the system based on the skin pigmentation of the subject, and less processing by the computers 10 or specialized sensors 20 are necessary. For example, color processing may be removed from any algorithms, machine learning or otherwise, and the cameras may not require color capability or color image processing. Moreover, color processing is affected by ambient lighting, especially outdoors or in indoor environments utilizing sunlight as a dominant source of lighting, therefore, the departure from the concerns of properly detecting skin pigmentation to adjust the deterrents 30 output and system efficacy is beneficial in simplifying the system 100.

This results in improved efficacy responses from subjects 50 which receive the deterrent, while maintaining lower interdiction energy levels than would be necessary with lasers at other wavelengths.

MPE is the minimum irradiance or radiant exposure that may be incident upon the eye or skin without causing hazardous effects or biological damage. The MPE varies by wavelength and duration of exposure and is documented in tables published in ANSI z136.1, ANSI z136.6 and IEC-60825-1 standards. Ensuring MPE safety varies based on at least one or more of the following factors: the wavelength of the laser, energy involved, location of photonic stimulation including skin or eyes and whether the exposure is radiant or irradiant.

In certain embodiments, the laser deterrent could comprise a Q-switch laser which can be used to ensure the laser is applied within MPE safety limits to not cause permanent injury. Q-switched lasers include laser technology that utilizes the principle of Q-switching to produce high-power laser pulses with precise and efficient performance. Q-switching is the process of changing the Q-factor of the laser resonator, which controls the accumulation and release of laser energy, allowing for the generation of intense laser pulses in short timeframes. Q-switched lasers are widely used in medical treatments such as tattoo removal, and skin resurfacing, stone dusting and soft tissue ablation and in urology for the treatment of Benign prostatic hyperplasia delivering powerful and precise laser pulses for optimal results. A Q-switch laser is configured to produce a pulsed output as opposed to a continuous wave (“CW”) laser which outputs a continuous beam. These pulses have higher output but are non-continuous and the system can precisely optimize each pulse for the desired effect.

As discussed below, the laser may be configured to emit pulses of specific energy levels, frequency of pulses and repetition rates depending on the desired deterrent action, system requirements, and available hardware.

To achieve Q-switching with the laser deterrents, an optical switch can be inserted into the laser cavity such that the laser waits for a certain level of population inversion of the ions before the switch opens. Once the optical switch opens, the light wave can traverse the cavity which depopulates the ions and results in a higher intensity, and power, pulse[s]. Alternative methods and configurations may also be used.

Additionally, by using pulsed Q-switched lasers, the MPE calculations are computed differently to that of a continuous wave laser as the exposure is not constant but rather based on the pulse duration and pulse frequency.

As discussed below, there are various environmental factors, targeting, decision- making, and laser characteristics that need to be addressed. Given the amount of time necessary for these determinations and configurations and laser signature and laser firing, an AI engine as discussed above can be used to manage all these factors. For example, if a subject is moving their head, walking running, turning their body and the laser is operating at repetition rate of 5-15 k, then the system 100 may have milliseconds to apply a deterrent. Accordingly, the system 100 can be configured to apply energy pulses from femtosecond pulses to under a few millisecond pulses in time with variable repetition rates.

The system 100 can also factor in a “tissue relaxation” period between pulses to allow heat to dissipate from a location on the subject 50 that has received a laser deterrent.

The AI engine input data and training include various situational data including environmental characteristics including time of day, lighting, temperature, humidity, location of sun, structures, material, or any other factors, distance, speed, movement, date analysis, biometrics and biometrics ID, and object recognition, eyeball recognition, head detection, hand detection, skin detection, pose detection, distance from protection area, and number of subjects. Under these conditions, an AI system may be necessary as the processing could not be performed using traditional computing (e.g., ladder programs) and certainly not via a human user. The laser deterrent can also be optimized or configured to maximize the photodisruption and thus pain effect impact while minimizing the photothermal exposure on the subject 50.

The AI engine processes all of the input information and sets the laser pulse signature including values for energy density, spot size, pulse duration, and repetition rate in addition to scan speed, scan direction, from the galvos.

Given the limited time window to apply a deterrent in certain circumstances (e.g., a moving subject), the system 100 must work in nanoseconds and thus an AI engine may be required to evaluate all the variables and pulse the laser within the time window.

The AI engine can be trained to identify information about the subject 50 such as clothing, gait, bags/carried items such as weapons, and protective equipment such as ear and eye protection. This can be used to identify a subject 50 as needing a deterrent, to select a deterrent, including how strong of a deterrent to apply, as well as for targeting specific locations.

As discussed below, a system using a TFL can induce photodisruption (10 ps-100 ns: 108-1010 W/cm2) by applying focused laser pulses on the scale of picoseconds or femtoseconds through nanoseconds depending on the system to develop power densities of 1012 W/cm2 and more. The electrical strength of this focused radiation is high enough to pull electrons out of the atoms, forming a plasma and producing an optical breakdown with shockwaves disrupting the tissue.

The photodisruption occurs, for example, by applying TFL laser deterrent to the skin which penetrates the dermis very shallowly such that the water in the dermis absorbs the water. The water molecule becomes excited and causes a mechanical shockwave to the tissue. This includes a shockwave effect which triggers the nociceptors to send a signal to the brain indicating pain. As discussed herein, the activated nociceptors and specific nerve fibers send quick signals which alert the brain before any tissue damage occurs.

This system 100 may also be designed to inflict a (potentially escalating) painful shock and thus prod and/or otherwise deter the subject. The system 100 can apply escalating deterrents if the subject 50 is not complying to the stimulus.

The TFL photonic energy is in an invisible wavelength, as such the subject 50 is unaware of the direction it its beam propagation. A “guide star” visible laser can be added to the interdiction system proving a visual stimulus on the subject's body or head for the subject 50 to see. This could cause anxiously for the subject 50 and potentially be used as an early level deterrent and/or warning. In addition, the guard force would be able to visually see who would be interdicted.

Regarding the specific laser characteristics, the system 100 can be modified as needed by the systemic requirements and/or any hardware restrictions. For purposes of the MPE calculation there are relationships between the average power (Watts), the exposure time (ms), pulse width (ns), and the repetition rate (kHz). This is shown, for example, in the following equations:

Thus, the various deterrent features can be determined and/or adjusted based on these factors to cause photodisruption. For example, using the laser wavelength as a constant, the system 100 can adjust the other factors to attain a desired energy density to cause photodisruption without photoablation. It should be noted, however, that the laser wavelength can also be adjusted such as when different laser deterrents are available in the system 100.

For purposes of inducing photodisruption, the desired energy density may be between 1-7 joules, though situational/environmental data, hardware restrictions, other previously used deterrents, and/or MPE calculations may also change these values. Nonetheless, using the wavelength as a constant, the system 100 can adjust the various factors to attain a desired energy density such as 3-7 joules.

For example, the repetition rate may be between 5,000 and 30,000 pulses per second and the system 100 could dynamically drop the beam diameter from 5-5.5 mm down to 2 mm.

Moreover, the system 100 may be configured to operate at certain power levels such as 25W of average power level such that the system may be small enough to be handheld and/or mounted such as on an uncrewed aerial vehicle.

As discussed below, targeting the laser deterrent is an important factor in designing and applying these systems and deterrents. Subjects 50, however, may be dynamic, e.g., moving various body parts and/or moving their bodies directionally before and after application of a deterrent (laser or otherwise).

The AI system is designed to account for such subject 50 movement, while maintaining the laser deterrent beam on a location on the subject 50, e.g., such as starting on the left side of the forehead below the tragus and above the eyebrow of the forehead and then scan horizontality an adult male forehead, e.g., “Bitragion breadth”. The breadth of the head from the right tragion to the left. (Tragion is the cartilaginous notch at the front of the activating a nerve group by example every 10 mm of distance from each other. The system design could be configured to not to fire on the same location more than once, as multiple firing on the same location could cause tissue destruction. For example, the laser would travel up to or around 14.5 cm (e.g., the distance between ends of eyebrows) and thus the system 100 could emit a family of nanoseconds pulses of photonic energy at each location across the forehead. As such the system 100 could fire 145 times across the travel path of the forehead. If, for example, a subject 50 is running, the system 100 may only have 50 ns of time to apply the deterrent because the head of the subject 50 is moving. Accordingly, the required energy density may be approximately 7 joules/cm2 to cause a response to the subject 50 in time. This power, however, may differ on the individual, the laser deterrent wavelength, targeted location on the user, distance to the user, and other factors and could be, for example, 4 joules/cm2.

The system 100 is designed to adjust the various characteristics to account for these changes while maintaining a safe level of laser exposure. For example, the system 100 may apply a smaller diameter beam which would be higher density than a larger beam diameter at the same energy.

The system 100 may be configured to apply a “pre-treatment” to the Primary afferent nociceptors (A-delta and C fibers). For example, the system 100 may be designed to first apply a first energy level deterrent which could be at a lower energy, identify the subject's response, and then determine a second energy level deterrent which could be higher or lower than the first energy level deterrent. If for example, the subject 50 does not comply with the desired behavior outcome, the system 100 could elect a second energy level which is higher than the first energy level.

Axons conveying information about pain fall into either the Ad group of myelinated axons, which conduct at about 20 m/s, or into the C fiber group of unmyelinated axons, which conduct at velocities generally less than 2 m/s. Thus, even though the conduction of all nociceptive information is relatively slow, there are fast and slow pain pathways that can be targeted.

The system 100 could be applied within a deterrent system that applies persistent deterrent actions. With a persistent deterrent action, the system 100 could also alternatively or in combination, apply different deterrents to distinct locations on the subject such as by targeting different locations on the subject 50.

Alternatively, or in combination, as part of the persistent deterrent system, the system 100 could be configured to apply different pulses signatures to different location and/or apply laser deterrents from a plurality of laser deterrent components (or other types of deterrents in available). Similarly, any of the targeting and deterrent techniques discussed herein could be implemented in a persistent deterrent system.

Moreover, in view of the moving subjects 50, the system 100 could be implemented with dynamic beam functionality. As the beam has a Gaussian distribution as shown in the following table, the beam diameter changes with distance to subject and thus the beam profile needs to be adjusted to maintain certain beam diameter such as 2 mm in this example. To accomplish this, the system 100 could employ a variable lens, such as a varioptic lens capable of quick and precise adjustments (e.g., Optotune™), to quickly change the focal length.

For example, if the deterrent system were mounted on a police officer (such as part of a vest), the system 100 could include radar, infrared, near-infrared, vision-based or other sensors to track a subject. As the subject 50 is moving, however, the laser deterrent not only has to be able to target the subject 50, but also stay within MPE limits based on atmospherics and distance.

The system 100 could locate the subject 50 and identify areas of interest such as those with exposed skin. Then, based on the distance between the laser deterrent and the subject 50, the system 100 could vary the laser deterrent beam characteristics. For example, it might be necessary to have a beam diameter of 2 mm to cause dermal agitation as discussed here, so the system 100 could adjust the pulse signature while maintaining the 2 mm diameter and cause the desired deterrent effect safely.

The system 100 could also implement a micro mirror system which can aim the deterrent beam at the tracked subject 50 within approximately 80 degrees FOV in combination with the above sensors or the officer's body camera. Additionally, the system 100 could include haptic sensor to indicate to the officer to move directionally to either better track the subject 50 or to get within the range of deterrent application such as so that the laser deterrent has an appropriate angle to reach the subject 50.

Depending on the situation, the identified and/or detected portions of the subject 50 with exposed skin, the type of selected deterrent, and the desired action by the subject in response to the deterrent, the system 100 could target different body locations of the subject 50. For example, as discussed below, the system 100 could target the subject's eye, ears, forehead, body, appendages including specific hands, feet, or fingers and toes, back of calf, back of thigh. The targeting can be accomplished using the sensors 20 and computer 10, including artificial intelligence techniques, to not only track the subject 50 and its movements, but also to hone in on specific locations to apply the deterrent.

The laser deterrent could also be used to heat, burn clothing which may be covering portions of the subject's 50 body. Once the clothing is compromised, the laser will then penetrate the subject's 50 exposed skin.

If the system 100 uses pulsed Q-switched lasers and/or a plurality of deterrent components, then the system 100 can also target multiple areas of the subject or multiple subjects either with different pulses or simultaneously (or near-simultaneously) with a multitude of laser deterrents.

The system 100 can also target more precise areas within the targeted portions of the subject 50 such as those with higher concentrations of nerve endings such as the face and mouth.

For example, the system 100 can target areas with high concentrations of nerve endings, often in exposed areas, such as the dorsal of the hand or median, ulnar, or radial nerves in the hand. Targeting these can result in significant pain response but also immediate action such as the release or otherwise inability to functionally wield a weapon that might be held in the hand.

Alternatively, or in addition, the system 100 can target the trigeminal nerve which includes multiple nerves, including the ophthalmic verve, the maxillary nerve, and the mandibular nerve which are located in and around the face.

Targeting these nerve groups can result in significantly higher deterrent impact on the subject, without causing serious or lasting injury, while using the same amount of energy as would be applied in other locations. Accordingly, the impact on the subject 50 is greater and more effective while still maintaining the same MPE safety values.

Additionally, as discussed above, the use of the Q-switched laser and their higher-powered pulses, the system 100 can target specific locations and induce pain, without causing lasting biological tissue or nerve damage.

Moreover, given the beam size, nanosecond short pulse duration and precision targeting of the lasers and the uses of the sensors 20, the system 100 can target adjacent locations on the skin where the pain is induced but that the MPE calculation is non-cumulative because it is not the same location receiving the photic exposure. For example, the laser deterrent[s] could target an array of locations on subjects' 50 body at a predetermined or calculated distance from each other, such as on a facial cheek, in consecutive or simultaneous pulses such that the MPE calculation for each pulse is not additive for the total MPE calculation. For example, the system could “scan” an area of the body and fire the laser at every 7-10 mm apart from the previous pulse or in a circular firing array that ensures the laser firing doesn't overlap the any of the prior pulse firing by at least 10 mm.

The photonic interdiction solution could work at any distance, e.g., from meters to hundreds of meters.

This interdiction body location can also be configured such that the dermal tissue is not heated or destroyed by any subsequent and adjacent pulses.

Observing and storing the video or photographic content in the memory for which area of the dermis location was fired upon, the system 100 could be designed to make sure that the same area is not targeted again for a predetermined period, e.g., at least 48 hours, unless overwritten by a supervisor.

These distance determinations can be based on the location of the subject 50 being targeted, the wavelength of the laser, and/or the energy of the laser including pulse power, duration, and frequency.

The AI engine can also be designed to “observe” the response from a subject 50 that was photonically fired upon. If the subject 50 moves away from the protected area 40, then the system 100 may no longer need to escalate its power level or fire upon the subject 50. If the subject 50 continues to breach the area 40, then the system 100 may determine another location on the subject's 50 body to target and increase the energy density level. The system 100 could also be configured to prevent the pulse density at any single location on the subject's 50 dermis to exceed the MPE unless there is human intervention instructing the system 100 to do so.

The laser deterrent according to certain embodiments can be configured to “pre-treat” nerve fibers so that less total energy is required to elicit a greater deterrent response. Specifically, the laser deterrent can be configured to first target a nerve ending area with a first pulse to “pre-treat” the location which causes a sensitivity in the subject 50. This can be accomplished by “rasterizing” a target area using lower energy (than what would be used to obtain the effect) pulses while “writing” a horizonal/vertical, circular or other geometry with a preliminary dose of photic energy to active the nerves. Based on the energy density applied, the subject 50 may or may not be aware of the rasterizing. Subsequent pulses applied after a certain amount of time will then have an increased impact of deterrent effectiveness while maintaining a lower aggerated MPE safety calculation as otherwise would have been calculated without the first pre-treatment.

The system 100 can incorporate a rasterization approach whereas a set of X & Y galvanometers, which deflect a light beam such as by using a mirror, paint a series of invisible photonic energy pulses in are area that will cover the subjects 50 face, body and or limbs. Each energy pulse could be on the order of 0.1-5 ms with a repetition rate of 100 Hz 25,000 Hz. The galvos could scan both vertically and horizontally producing energy pulses which come in contact with a subject's skin. These pulses could be very close together such that their center-to-center distance is only 5 mm or as far apart as required to protect an area for which multiple indicate are attempting to penetrate the area.

In certain embodiments, the system 100 could be configured to apply a “forcefield” around an area to subject any humans or animals approaching an area. Specifically, the system 100 can target any approaching or encroaching subjects 50, such as a human or animal, that go within a certain distance of a protected area 40. This distance could be defined as a line or other shape such that effectively a “forcefield” is created along the shape thus creating a boundary between the protected area 40 and the un-protected area.

In another embodiment, the system 100 can be used to interdict a specific individual or multiple individuals. No one other than the selected individuals would be targeted and thus interdicted. The individuals could be identified by facial recognition technology or other biometrics insights. Furthermore, a security officer could make the decision. In this embodiment, there is no collateral damage, only the selected subject 50 would be subject to detection technology.

The system can also be configured to impact Aβ nerve fibers located in the skin of the subject 50. Aβ nerve fibers are cutaneous touch receptors including fast-acting mechanoreceptors. This can be accomplished, for example, by targeting highly sensitized regions and/or regions with high densities of nerve fibers.

These receptors are capable of rapidly reacting to pain caused by dermal agitation faster than typical cells react to thermal agitation. Accordingly, by quickly shocking these receptors akin to a pin prick, the system 100 can elicit a pain response, and consequently a reaction from the subject 50 to stop its actions more effectively and quicker than if the system 100 had to use the laser deterrent to induce thermal agitation which could take hundreds of milliseconds.

For example, in some embodiments, the system 100 net effects on the subject can be specifically configured to cause a series of uncontrollable or involuntary reflex-based reactions by the targeted subject 50 such as those reflex actions that are protective, automatic, and rapid response to stimulus that do not involve the brain but often coordinated by the spinal cord, intrinsic reflexes, and/or learned reflexes that do involve stimulus and response reaching the brain.

To cause photodisruption without photoablation, the system 100 can be configured to run at certain specifications which can be set and controlled by the AI engine.

For example, depending on the energy available from lasers such as TFL discussed herein, 100-500 ms pulses at 2 mm beam size may be all that is required to cause thermal damage. Accordingly, by using pulses such as 200 nanoseconds with 2 mm beam size and a controllable repetition rate, the system 100 can cause photodisruption without causing tissue damage.

These limited pulse durations lead to a shortened “time on target” as compared to continuous wave lasers and even to other pulsed lasers that cause thermal tissue damage. Time on target is a component of the calculation to obtain desired effect without entering thermal damage range.

Numeric Pain Rating Scale (“NPRS”) values also differ depending on the body location (e.g., the dorsum v. the palm) as well as the duration of the exposure. In the NPRS scale, a value of “0” is no pain while “10” is the maximum level of pain where a “3” is about the threshold for pain. Accordingly, depending on the type of laser, the duration of exposure and targeting location can be adjusted to target a NPRS level around a certain number such as 3 as a first energy level and higher for a second energy level deterrent.

This results in temporary pain, rather than any lasting damage over a week.

This can be accomplished, for example, by targeting certain nerve fibers as discussed above. This can also result in a small “shockwave” effect by applying multiple quick pulses that induces localized pain without permanent tissue destruction.

With the so-called shockwave, the subject 50 may feel a sensation similar to a pinch. If the deterrent continues for more time on target, then the subject 50 would feel pain then after even more time on target tissue injury can occur. Accordingly, there can be multiple levels of deterrent applied by the same laser depending on the time on target.

In certain embodiments, it is desirable to cause the subject 50 to feel the oncoming sensation of something that they sense as unusual and dangerous and react even before pain is felt. This can be accomplished by adjusting the laser configuration and laser signature factors discussed above including limiting the time on target. Moreover, as noted above, the MPE safety model is location on body based so other areas can be targeted.

Additionally, all the above discussed factors may need to be adjusted based on external factors such as ambient/day light, subject skin temperature, humidity, subject sweat, or other human variability factors of the subject. The system can adjust this by monitoring (via CV or other sensors) the subject 50 reaction to a first or earlier deterrent and adjusting future deterrent according to rules, machine learning models, or other factors.

The system 100 can also be used to leave a temporary “tag” mark on an individual such that the subject 50 can be identified following the application of the deterrent or write marking code such as Universal Product Code on subjects' dermis indicating the GPS location and time that the interdiction was experienced.

For example, the system 100 may leave a small mark which will heal in a few days, but still be visible to authorities for several days. Specifically, thermoablation edema tagging IG of human using (GPS location and time of day embedded)

The laser deterrent(s) 30 may be configured to target in and around a subject's eye or eyes. The laser deterrent(s) 30 may be configured to target different locations on a single eyeball either with different pulses from the same laser deterrent 30, from different laser deterrents, in the same cycle or in separate cycles. For example, the system 100 could target a ring of 7-10 mm around the eyeball. This could be multiple locations with that ring or targets outside that distance from each other to avoid combinational effects.

The laser deterrents 30 could be configured to target the cornea, and areas around, of a subject 50 consistent with the above discussed techniques. For example, laser deterrent beams directed to the side, top, and into the eye. Moreover, the system 100 can be configured to target the cornea, and not penetrate the eye into the macula, so it is eye-safe.

The system 100 can also be configured to “dither” such that the system 100 undulates/fluctuates to avoid repeatedly hitting the exact same location. For example, if the system 100 does not need much time for a reaction based on the situational data and the laser configurations, the system 100 could drop the exposure time (e.g., to 1 ms) and apply 6.5 k-10 k average power or per pulse at around 3.5J/cm2.

Additionally, using the Q-switched lasers and persistent real time tracking from the sensors, the system 100 can follow the head of the subject 50, adjust laser position with the quick pulses, and send pulses to multiple areas around the eye to anticipate movement.

This also works with deterrent system which attempts to model subject behavior and/or otherwise predict subject behavior. For example, if the laser deterrent 30 is directed from a certain direction, the subject 50 may be anticipated to turn or move in a different direction. The system 100 can account for this by adjusting the location of different pulses to different locations and/or apply deterrents located in different positions. This can be accomplished using the AI engine.

In an embodiment using visible light deterrents, by using a plurality of laser deterrents located in different positions it is possible to keep the subject's vision obfuscated or otherwise deter the subject 50 from anywhere. For example, the system 100 could constantly target both the front and periphery of the subject's vision such that the subject's vision stays obfuscated even if the subject's head turns.

The multiple laser deterrents discussed herein could also be configured to operate independently or share a duty cycle.

Moreover, if the laser deterrents 30 are sufficiently physically separated, the effect of the laser beam on the subject 50 is not additive for purposes of MPE calculations.

Laser deterrents according to the above description may have limited range of view (e.g., 80-degree field of view) though may also be capable of movement and/or rotation depending on the available hardware and design requirements.

In certain embodiments, there could be a plurality of laser deterrents covering an area such as in four corners of a room. In such an orientation, the four laser deterrents could cover all 360 degrees of the room in one plane.

For example, in such an orientation with only a single subject 50, the multiple visible laser deterrents could focus on the subject's eyes as noted above such that the subject 50 could not avoid the obfuscation.

If there were a plurality of subjects 50, for example, the lasers deterrent could be configured to brighten the room to disorient the subjects using visible light. Each laser deterrent could be configured to emit high levels of light such as 100 k lumens such that the subjects could not look in any direction without recoiling from the light.

The laser deterrents could also be configured to target the plurality of subjects 50 according to the techniques discussed above. This could include each laser targeting different subjects 50 and/or shifting between subjects 50 with different pulses within a duty cycle, and/or otherwise sharing duty cycle.

The various laser deterrents can also manage MPE safety in real time by self-adjusting the above factors and/or changing targeting techniques to maintain under the MPE limits which can be controlled by the AI engine.

The system 100, including the AI engine, can also be configured to weigh different factors differently, including based on the environmental circumstances and application. For example, the initial deterrent may be different if a subject 50 is entering a nuclear facility that if worn by a police officer at a public location.

Additionally, the various deterrents and sensors discussed herein could be accommodated on many different form factors. For example, in addition to fixed structures or integrated into a police uniform as discussed above, they could also be integrated into a movable vehicle such as an Uncrewed Aerial Vehicle (“UAV”).

In an embodiment where the laser deterrents 30 are integrated into a UAV, the system 100 could also move the UAV[s] to follow and/or track the subject and maintain the targeting techniques discussed above including to maintain vision obfuscation.

Systems according to the techniques discussed here could be used in various applications in addition to the ones specifically discussed above.

For example, and especially in a case where the deterrent system includes UAVs, the system could be used to manage individuals and/or crowds while limiting panic. As noted above, the system can be configured to immobilize a subject with limited impact on the surrounding individuals by non-visible laser and the management of deterrent applied to the subject.

This can also be applied to managing crowds. For example, the system could be configured to subject specific individual[s], such as those on the outside or leading a crowd, to either stop them or redirect them such as by targeting a cheek and causing the subject to turn directions. Using the Q-switch pulses and/or a plurality of laser deterrents, the system can target several subjects at once, applied multiple deterrents to the same subject, apply deterrents to a plurality of subjects, and these deterrents could be applied via different pulses in the same duty cycle and/or from the different laser deterrent.

In these circumstances, the system 100 can also consider the UAV characteristics including but not limited to the size and maneuverability of the UAV as well as battery considerations including the power required for the UAV to traverse the necessary route, which can also be determined by the system, and the power required to apply the laser deterrents.

The system 100 can also be configured to target and deter non-human species such as dogs, frogs, bears, horses, wolves and coyotes, cattle and livestock animals in the zoo, small nuisance animals, and even fish such as sharks. The system 100 could not only deter the animals but could be used to “move the animal” such as a cow to a greener pasture to feed. Similarly, the system could be used to deter nuisance birds such as in airport traffic to apply a non-lethal deterrent to prevent birds from negatively interacting with airplanes.

The system 100 illustrated in FIG. 1 is illustrative and not limiting, e.g., can include one or more of components shown and could include components not shown, depending on the desired application of the unit. Further, the arrangement of these components is not limited to the example shown in the figures.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described to best explain the principles of the invention and the practical application, and to enable others of ordinary skill in the art to understand the invention for various embodiments with various modifications as are suited to the particular use contemplated.

Although this disclosure has been described in connection with specific forms and embodiments thereof, it will be appreciated that various modifications other than those discussed above may be resorted to without departing from the spirit or scope of the disclosure as defined in the claims. For example, functionally equivalent elements may be substituted for those specifically shown and described, certain features may be used independently of other features, and in certain cases, particular locations of the elements may be reversed or interposed, all without departing from the spirit or scope of the disclosure as defined in the claims.

I claim:

1. A deterrent system comprising:
a laser configured to operate between 1000 nm and 2100 nm;
a controller; and
a detector;
wherein the controller is configured to instruct the laser to apply Q-switch pulses of laser to act as a deterrent to a subject.

2. The deterrent system according to claim 1, wherein the laser is a Thulium Fiber Laser, configured to operate between 1800 nm and 2100 nm.

3. The deterrent system according to claim 1, wherein the laser is a YAG Laser, configured to operate between 1000 nm and 2000 nm.
